(19) United States
(12) Patent Application Publication
(10) Pub. No.: US 2006/0294413 A1
(43) Pub. Date: Dec. 28, 2006

(54) Fault tolerant rolling software upgrade in a cluster

(76) Inventors: Frank S. Filz, Beaverton, OR (US); Bruce M. Jackson, Portland, OR (US); Sudhir G. Rao, Portland, OR (US)

Correspondence Address: LIEBERMAN & BRANDSDORFER, LLC, 802 STILL CREEK LANE, GAITHERSBURG, MD, 20878, US

(21) Appl. No.: 11/168,858

(22) Filed: Jun. 28, 2005

(51) Int. Cl. G06F 11/00

(52) U.S. Cl. 714/4

(57) ABSTRACT

A method and system are provided for conducting a cluster software version upgrade in a fault tolerant and highly available manner. There are two phases to the upgrade. The first phase is an upgrade of the software binaries of each individual member of the cluster, while remaining cluster members remain online. Completion of the first phase is a pre-requisite to entry into the second phase. Upon completion of the first phase, a coordinated cluster transition is performed during which the cluster coordination component performs any required upgrade to its own protocols and data structures and drives all other software components through the component specific upgrade. After all software components complete their upgrades and any required data conversion, the cluster software upgrade is complete. A shared version control record is provided to manage transition of the cluster members through the cluster software component upgrade.

### BACKGROUND OF THE INVENTION

1. Technical Field

This invention relates to upgrading software in a cluster. More specifically, the invention relates to a method and system for upgrading a cluster in a highly available and fault tolerant manner.

2. Description of the Prior Art

A node could include a computer running single or multiple operating system instances. Each node in a computing environment may include a network interface that enables the node to communicate in a network environment. A cluster includes a set of one or more nodes which run cluster coordination software that enables applications running on the nodes to behave as a cohesive group. Commonly, this cluster software is used by application software to behave as a clustered application service. Application clients running on separate client machines access the clustered application service running on one or more nodes in the cluster. These nodes may have access to a set of shared storage typically through a storage area network. The shared storage subsystem may include a plurality of storage medium.

FIG. 1 is a prior art diagram (10) of a typical clustered system including a server cluster (12), a plurality of client machines (32), (34), and (36), and a storage area network (SAN) (20). There are three server nodes (14), (16), and (18) shown in the example of this cluster (12). Server nodes (14), (16), and (18) may also be referred to as members of the cluster (12). Each of the server nodes (14), (16), and (18) communicate with the storage area network (20), or other shared persistent storage, over a network. In addition, each of the client machines (32), (34), (36) communicates with the server machines (14), (16), and (18) over a network. In one embodiment, each of the client machines (12), (14), and (16) may also be in communication with the storage area network (20). The storage area network (20) may include a plurality of storage media (22), (24), and (26), all or some which may be partitioned to the cluster (12). Each member of the cluster (14), (16), or (18) has the ability to read and/or write to the storage media assigned to the cluster (12). The quantity of elements in the system, including server nodes in the cluster, client machines, and storage media are merely an illustrative quantity. The system may be enlarged to include additional elements, and similarly, the system may be reduced to include fewer elements. As such, the elements shown in FIG. 1 are not to be construed as a limiting factor.

There are several known methods and systems for upgrading a version of cluster software. A software upgrade in general has the common problems of data format conversion, and message protocol compatibility between software versions. In clustered systems, this is more complex since all members of the cluster must agree and go through this data format conversion and/or transition to use the new messaging protocols in a coordinated fashion. One member cannot start using a new messaging protocol, hereinafter referred to as protocol, until all members are able to communicate with the new protocol. Similarly, one member cannot begin data conversion until all members are able to understand the new data version format. When faults occur during a coordinated conversion phase, the entire cluster can be affected. For example, in the event of a fault during conversion, data corruption can occur in a manner that may require invoking a disaster recovery procedure. One prior art method for upgrading cluster software requires stopping the entire cluster to upgrade the cluster software version, upgrading the software binaries for all members and then restarting the entire cluster under the auspices of the new cluster software version. A software binary is executable program code. However, by stopping the entire cluster, there are no server nodes available to service client machines during the upgrade as the cluster application service is unavailable to the client machines. In some cases the data conversion phase must complete before the cluster is able to provide the application service. Another known method supports a form of a rolling upgrade, wherein the cluster remains partially available during the upgrade. However, the prior art rolling upgrade does not support a coordinated fault tolerant transition to using the new data formats and protocols once each individual member of the cluster has had its software binaries upgraded.

There is therefore a need for a method and system to employ a rolling upgrade of cluster version software that does not require bringing the cluster offline during the upgrade, and is capable of withstanding faults during the coordinated transition to using new protocols and data formats.

### SUMMARY OF THE INVENTION

This invention comprises a method and system to support a rolling upgrade of cluster software in a fault tolerant and highly available manner.

In one aspect of the invention, a method is provided for upgrading software in a cluster. Software binaries for each member of a cluster are individually upgraded to a new software version from a prior version. Software parity for the cluster is reached when all cluster members are running the new software version binaries. Each cluster member continues to operate at a prior software version while software parity is being reached and prior to transition to the new software version for the cluster. After reaching software parity a fault tolerant transition of the cluster is coordinated to the new software version. The fault tolerant transition supports continued access to a clustered application service by application clients during the transition of the cluster to the new software version.

In another aspect of the invention, a computer system is provided with a member manager to coordinate a software binary upgrade to a new software version for each member of the cluster. Software parity for the cluster is reached when all cluster members are running the new software version binaries. Each cluster member continues to operator at a prior software version while software parity is being reached and prior to transition to the new software version for the cluster. A cluster manager is provided to coordinate a fault tolerant transition of the cluster software to a new version in response to reaching software parity. The cluster manager supports continued application service to application clients during the coordinated transition.

In yet another aspect of the invention, an article is provided with a computer useable medium embodying computer useable program code for upgrading cluster software. The computer program includes code to upgrade software binaries from a prior software version to a new software version for each member of the cluster. In addition, computer program code is provided to reach software parity for each member of the cluster. Software parity for the cluster is reached when all cluster members are running the new software version binaries. Each cluster member continues to operator at a prior software version while software parity is being reached and prior to transition to the new software version for the cluster. Computer program code is provided to coordinate a fault tolerant transition of the cluster to a new cluster software version responsive to completion of the code for upgrading the software binaries for the individual cluster members. The computer program code for coordinating the transition supports continued access to a clustered application service by application clients during the transition of the cluster to the new software version.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a prior art block diagram of a cluster and client machines in communication with a storage area network.

FIG. 2 is a block diagram of a version control record.

FIG. 3 is a flow chart illustrating the process of reaching software parity in a cluster.

FIG. 4 is a block diagram of an example of the version control record prior to changing the software version of any of the components

FIG. 5 is a block diagram of the versions record when the software upgrade of the members is in progress.

FIG. 6 is a block diagram of the version control record when software parity has been attained and the members of the cluster are ripe for a cluster upgrade

FIG. 7 is a flow chart illustrating a first phase of the coordinated cluster upgrade.

FIG. 8 is a block diagram of the version control record when software parity has been attained and the cluster version upgrade has been started.

FIG. 9 is a flow chart illustrating a second phase of the cluster upgrade according to the preferred embodiment of this invention, and is suggested for printing on the first page of the issued patent.

FIG. 10 is a block diagram of the version control record when the cluster upgrade is in progress and the cluster coordination component has completed its upgrade

FIG. 11 is a block diagram of the version control record when the cluster upgrade is in progress and the cluster coordination component and an exemplary transaction manager component have completed their upgrades.

FIG. 12 is a block diagram of the version control record when the cluster upgrade from version 1 to version 2 is complete.

FIG. 13 is a block diagram of a cluster with the cluster and member managers implemented in communication with a member manager.

FIG. 14 is a block diagram of a cluster with the cluster and members managers implemented in a tool.

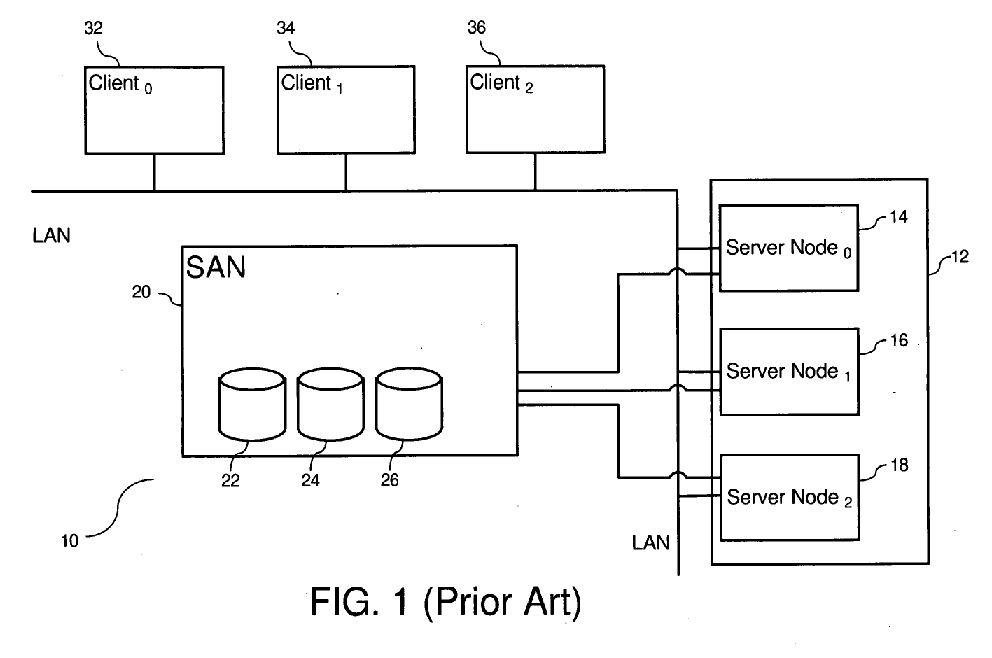

### DESCRIPTION OF THE PREFERRED EMBODIMENT

### Overview

When an upgrade to cluster software operating on each server node is conducted, this process is uniform across all server nodes in the cluster. New versions of cluster software may introduce new data types or format changes to one or more existing data structures on shared storage assigned to the cluster. Protocols between clustered application clients and cluster nodes providing the clustered application service may also change between different releases of cluster software. Nodes running a new cluster software version cannot begin to use new data formats or protocols until all nodes in the cluster are capable of using the new formats and/or protocols. In addition, the cluster members must also be capable of using former protocols and understanding the former data structure formats until all cluster members are ready to begin using the new formats. In this invention, a shared persistent version control record is implemented in conjunction with a cluster manager to insure data format and protocol compatibility during the stages of a cluster software upgrade. A version control record is used to maintain information about the operating version of each component of the cluster software, as well as application software in the cluster. At such time as software binaries for all nodes have been upgraded, the cluster can go through a coordinated transition to the new data formats and messaging protocols. This process may include conversion of existing formats into the new formats. During upgrade of the cluster software, the version control record for each component will be updated to record version information state. Each component records the versions it is capable of understanding, the version it is attempting to convert to, and the current operating version. When each component completes its conversion to the new version, the component updates its current software version in the version control record, and that component upgrade is complete. Once the software upgrade for each component in the cluster is complete, as reflected in the version control record, the cluster software upgrade is complete.

### Technical Details

In a distributed computing system, multiple server nodes of a cluster are in communication with a storage area network which functions as a shared persistent store for all of the server nodes. The storage area network may include a plurality of storage media. A version control record is implemented in persistent shared storage and is accessible by each node in the cluster. It is appreciated that a storage area network (SAN) is one common example of persistent shared storage, any other form of persistent shared storage could be used. The version control record maintains information about the current operating version and the capable versions for each component of the clustered application running on each node in the cluster. The version control record is preferably maintained in non-volatile memory, and is available to all server nodes that are active members of the cluster as well as any server node that wants to join the cluster.

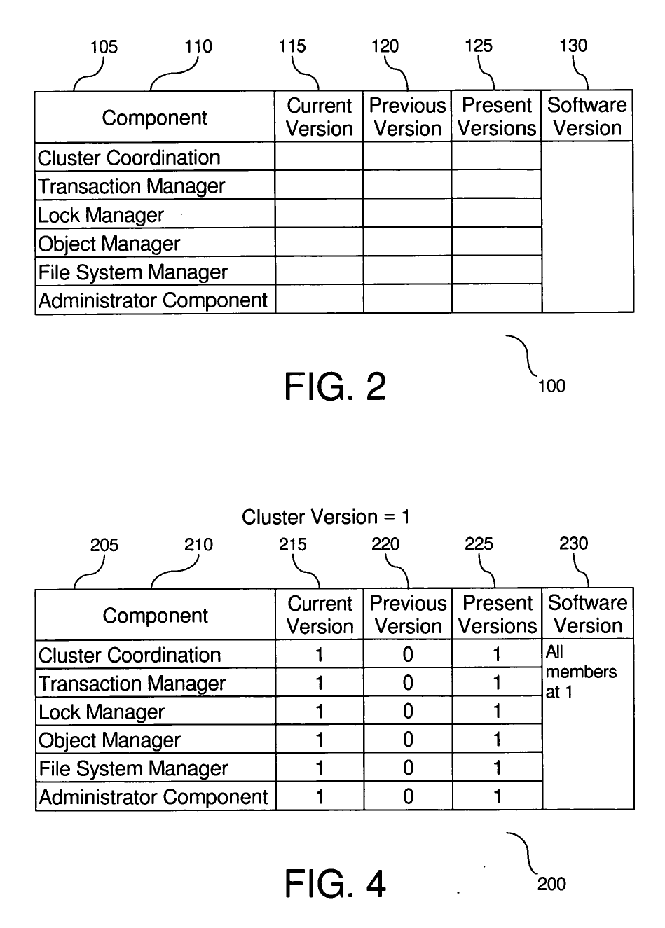

FIG. 2 is a block diagram (100) of an example of a version control record (105) in accordance with the present invention. As shown, the versions table (105) has five columns (110), (115), (120), (125), and (130), and a plurality of rows. Each row in the record is assigned to represent one of the software components that is part of the clustered application. The first column (110) identifies a specific component in the exemplary clustered application service of the IBM® SAN Filesystem. There are many components in a filesystem server, each of which may undergo data format and/or message protocol conversions between software releases. Example components in the IBM® SAN Filesystem, include, but are not limited to, the following: a cluster coordination component, a filesystem transaction manager, a lock manager, a filesystem object manager, a filesystem workload manager, and an administrative component. The cluster coordination component coordinates all cluster wide state changes and cluster membership changes. Any component may have shared persistent structures which have an associated version and can evolve between releases, such as the objects stored by the filesystem object manager. A component may also have messaging protocols that may evolve between releases, such as the SAN filesystem protocol, the intra-cluster protocol used by the cluster coordination component in a SAN filesystem, or the protocol used to perform administrative operations on a SAN filesystem cluster node. An upgrade of cluster software may include upgrading the protocol used to coordinate cluster transitions, i.e. the cluster coordination component. This component is upgraded synchronously during the coordination of upgrading all other components. The second column in the example of FIG. 2 identifies the current operating version of the specified SAN filesystem component (115). This is the operating version for all instances of the component for all cluster members, and a member joining the cluster must adhere to the operational version although it is capable of different versions. The third column in the example of FIG. 2 identifies the previous operating version of the specified component (120). This is the previous operating version for all instances of the component for all cluster members. The fourth column of the example of FIG. 2 identifies the present operating versions of the specified component for all cluster members (125). For example, when an upgrade is in progress a specified component is capable of operating at both the prior version and the current version. When the upgrade of the component is complete, the specified component commits only to the new version and is thus only capable of operating at the new version. A component commits its upgrade by removing all entries other than the new version from the list in the present versions column. The fifth column (130) of the example of FIG. 2 identifies the software binary version of all of the members of the cluster. For example, it might be that different members of the cluster are operating at different software versions. Accordingly, the versions control record stores past and current versions of software for each component in the cluster.

The following few paragraphs will illustrate how members of the cluster upgrade their components. The first part of the process of upgrading an operating version of the cluster is to upgrade the software binaries installed on each cluster member, and the second part of the process is to coordinate an upgrade of the operating version of the cluster to the new version. When each member of the cluster has completed a local upgrade of its software binaries, as reflected in the version control record, software parity has been reached. In one embodiment, the software version column (130) may contain an array wherein each member of the cluster owns one element of the array based on a respective node identifier and records its binary software version in its respective array element as it rejoins the cluster. All members are thus aware of the software binary version that each other member is running. Software parity is attained, when all elements of the array contain the same software version. Software parity is a state when each member of the cluster is operating at an equal level, i.e. the same binary software version. Once software parity is attained, all nodes will be running software binary version N, with the cluster operating at version N−1, i.e. N−1 shared data structure formats and N−1 protocols. Attaining software parity is a pre-requisite to entering the second part of the upgrade process in which a coordinated transition of all cluster members to a new operational cluster version is conducted.

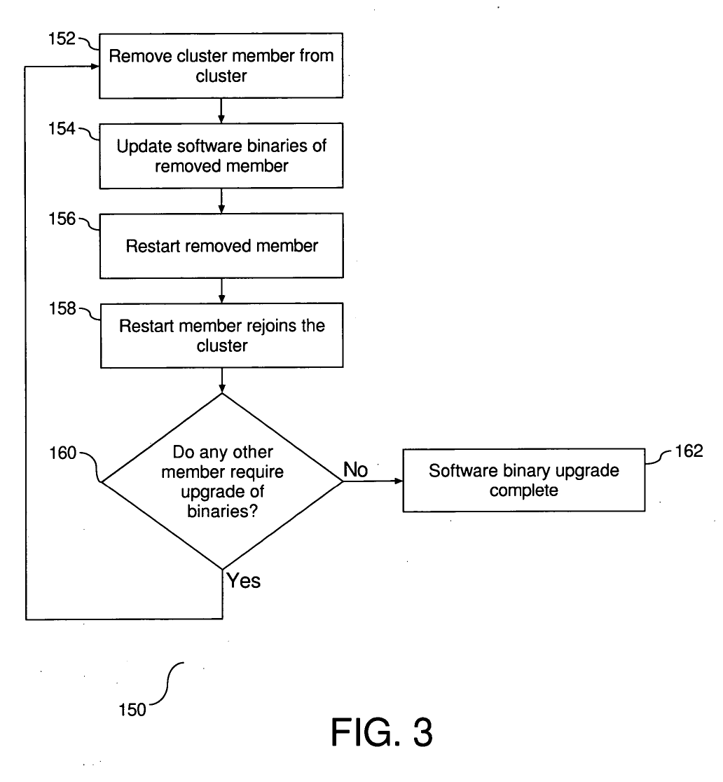

FIG. 3 is a flow chart (150) illustrating the process of reaching software parity in a cluster. Each cluster member has executable software known as software binaries. To upgrade local software binaries, a cluster member is removed from the cluster and stopped (152). The application workload of the removed cluster member may be relocated to a remaining cluster member so that application clients may continue to operate. Thereafter, the software binaries of the removed member are updated (154), the member is restarted (156), and the restarted member rejoins the cluster (158). When the removed member rejoins the cluster, the software version column (130) of the version control record (105) is updated to reflect the updated software binaries of the individual member that has rejoined the cluster. Software components in the rejoined cluster member use the shared version control record to determine that they are to use the prior version for messaging protocols and data formats as that is the version being used by existing members of the cluster. Thereafter, a determination is made if there are any other members of the cluster that require an upgrade of their software binaries to attain software parity (160). A positive response to the test at step (160) will result in a return to step (152), and a negative response to the test at step (160) will result in completion of an upgrade of the software binaries for each member of the cluster (162). As each individual member of the cluster experiences a software upgrade, it retains the ability to operate at both the previous version and the upgraded version. When all members of the cluster have upgraded their software binaries, software parity has been attained. Accordingly, reaching software parity, which is a pre-requisite to a coordinated transition of all cluster members to a new operational cluster version, occurs on an individual member basis.

The following three diagrams in FIGS. 4, 5, and 6 illustrate the version control record and the changes associated therewith as each member upgrades its software and reflects the changes in the version control record. In the examples illustrated in the figures shown herein, the cluster is upgrading its software from version 1 to version 2. FIG. 4 is a block diagram (200) of an example of the version control record (205) at steady state prior to any upgrade actions. The record indicates each member of the cluster is operating at cluster version 1. The current software version for each component is at version 1, as shown in the current version column (215). The previous version column (220) indicates there is no prior software version for any of the components, the present versions column (225) indicates the present version of the software for each component is at version 1, and the software version column (230) indicates that each individual member of the cluster is running version 1 of the software binaries. Accordingly, as reflected in the version control record (205), no members of the cluster have upgraded their software binaries to version 2.

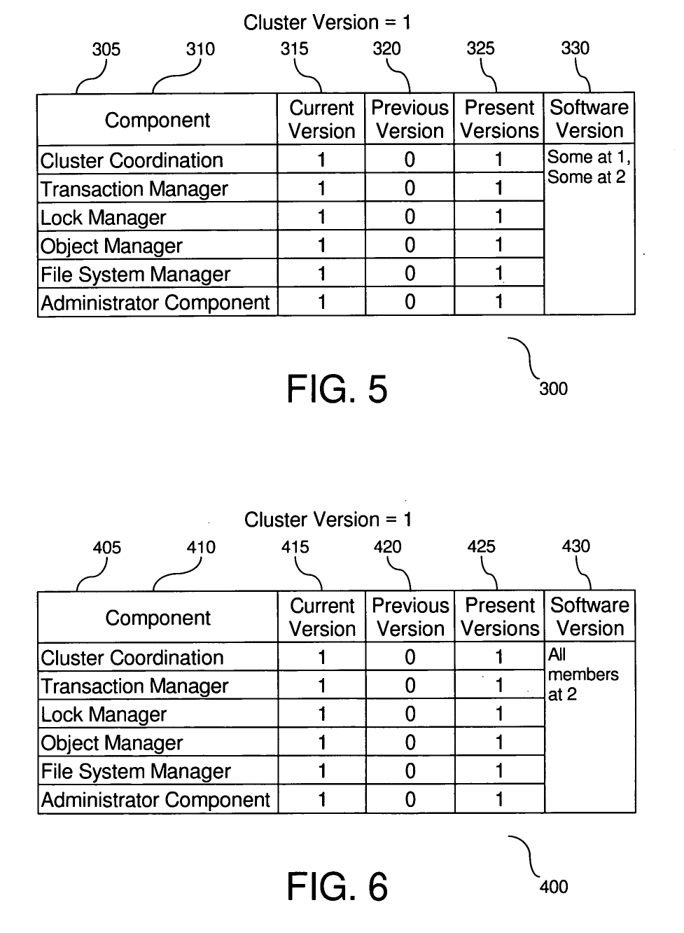

FIG. 5 is a block diagram (300) of the version control record (305) when a software binary upgrade of the cluster members is in progress but software parity has not yet been reached. This is recorded in the software version column (330), which shows that some members are operating at binary version 1 and some members are operating at binary version 2, but the cluster and its components are still at operational version 1. Accordingly, as reflected in the version control record, a cluster member software binary upgrade to version 2 is in progress for the cluster.

FIG. 6 is a block diagram (400) of the version control record (405) when software parity has been attained and the members of the cluster are ripe for a coordinated cluster upgrade, but the cluster wide upgrade has not been initiated. As shown, the record indicates each member of the cluster is operating at cluster version 1. The upgrade of the software binary version for each member is recorded in the software version column (430), and all members are running binary version 2. Each component in the current version column (415) is still shown at version 1, each component in the previous version column (420) indicates there is no prior software version for any of the components, and each component in the present versions column (425) indicates the present version of the software for each component is at version 1. Accordingly, a coordinated cluster version upgrade is now possible.

Once software parity has been attained for each member of the cluster, as reflected in the version control record shown in FIG. 6, the cluster is capable of a coordinated upgrade to a new operating version. Transition of the cluster involves message protocol and data structure transitions. Any protocols used by the cluster that change with a cluster software version upgrade, must also change during the cluster upgrade. Similarly, any conversions of data structures must either be completed or initiated and guaranteed to complete in a finite amount of time.

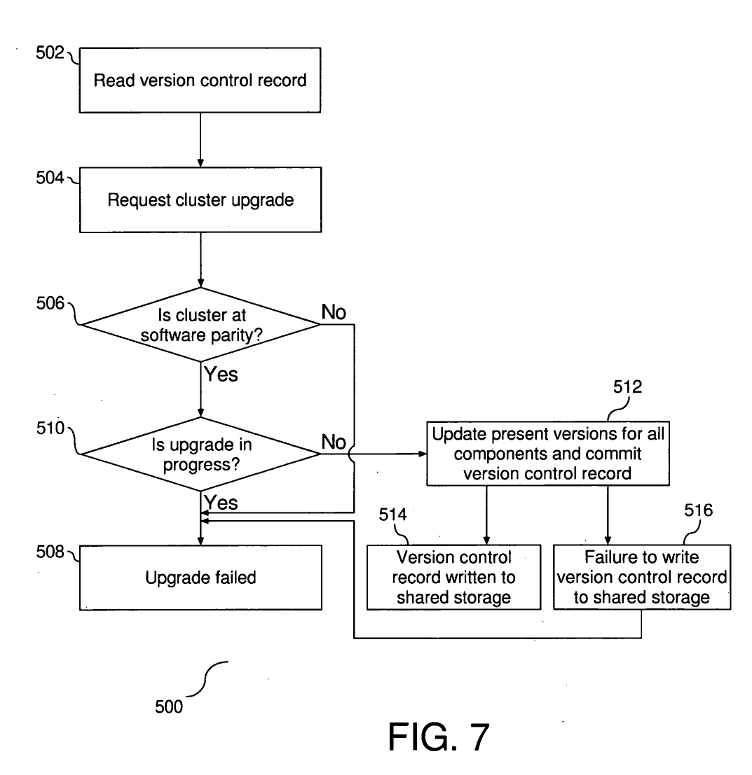

FIG. 7 is a flow chart (500) illustrating the process for initiating upgrade of a cluster version once software parity has been attained. When a cluster upgrade is initiated, the version control record is read (502) followed by a request for a cluster version upgrade (504). Thereafter, a test is conducted to determine if the cluster has attained software parity by inspecting the software version column of the version control record (506). A negative response to the test at step (506) will result in an upgrade failure (508), as software parity is a pre-requisite for a cluster version upgrade. However, a positive response to the test at step (506) will result in a subsequent test to determine if a prior cluster upgrade is in progress by inspecting the present versions column of the version control record (510). Any component that is still undergoing a conversion from one version to another will have more than one present version. An upgrade to a new version may only be done when a previous upgrade is complete so a positive response to the test at step (510) will result in a rejection of the upgrade request (508). However, a negative response to the test at step (510) is a reflection that all components have a single present version and will allow the upgrade to proceed. The present versions column will be updated to contain the current and targeted new versions for each component that is going through a version upgrade during a particular software upgrade. In one embodiment, some components may have no upgrade between releases, and these components see no update to the present versions column. Once the version control record is written to persistent shared storage, the cluster is committed to going through the upgrade (514). A failure to write the version control record to persistent storage will result in no commitment to going through the upgrade, and the cluster will continue to operate at the previous version until the updated version control record is successfully written to persistent storage (516). Accordingly, the first part of the cluster upgrade ensures that software parity has been attained and that the version control record update commits the cluster to the upgrade.

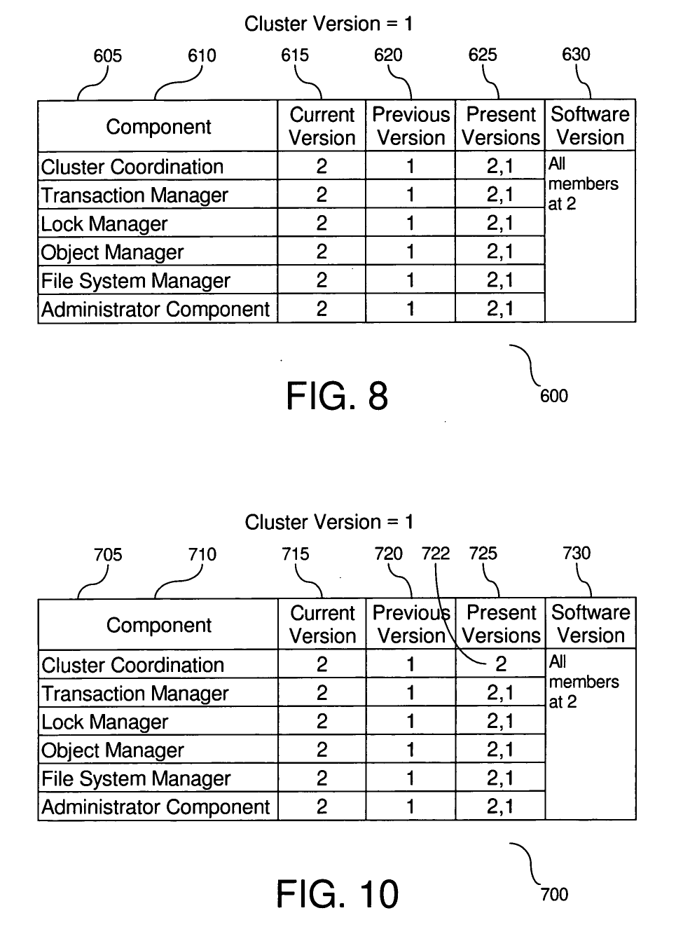

FIG. 8 is a block diagram (600) of the version control record (605) when software parity has been attained and the cluster version upgrade has been started. As shown, the record indicates the overall cluster operational version is still version 1. Each component in the current version column (615) is shown at version 2, each component in the previous version column (620) indicates the prior version at 1, each component in the present versions column (625) indicates the present version of the software for each component is capable of operating at versions 1 and 2 and that an upgrade is in progress for this component. The software versions column (630) indicates that all members of the cluster have been upgraded to software binary version 2. As reflected in the version control record, the cluster upgrade has been started by updating the present versions column to reflect both the current cluster version and the target upgrade cluster version.

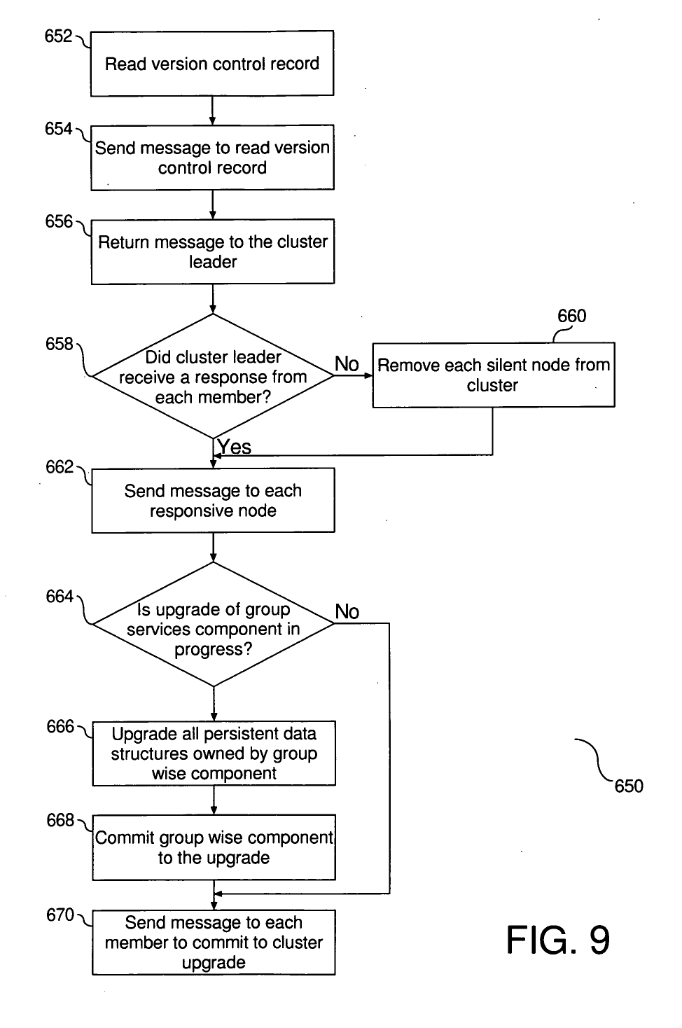

FIG. 9 is a flow chart (650) illustrating a coordinated cluster upgrade following commitment of the version control record by writing the updated version control record to shared persistent storage. The first step of this process requires the cluster leader to re-read the version control record (652). A message is then sent from the cluster leader to each cluster member instructing each of the members to read the version control record so that each cluster member has the same view of the version control record (654), and to return a message to the cluster leader that the respective member has read the current version of the record (656). Following step (656), a test is conducted to determine if the cluster leader has received a response from each cluster member (658). A negative response to the test at step (658) will result in removal of the non-responsive node from the cluster (660). Similarly, a positive response to the test at step (658) will result in the cluster leader sending a second message to each cluster member that responded to the first message indicating the proposed cluster members for the cluster version upgrade (662). The cluster leader starts the cluster version upgrade of its own data structures by conducting a test to determine if an upgrade of the cluster coordination component is in progress (664). This test requires a review of the present versions column in the version control record to see if the cluster coordination component reflects more than one version. A positive response to the test at step (664) results in an upgrade of persistent data structures owned by the cluster coordination component (666), followed by an update of the cluster coordination component column of the present version column of the version control record (668). The cluster coordination component removes the prior component version from the present versions column in the version control record, while retaining the prior version for the upgrade in the record. The cluster coordination component is the first component in the cluster to commit to the upgrade. Following step (668) or a negative response to the test at step (664), the cluster leader sends a message to each cluster member reflected at step (660) to commit to the cluster upgrade (670). When each cluster member commits to the upgrade it re-reads the version control record and the committed cluster coordination component re-starts all other components. As each component restarts, they individually determine if they have to upgrade to a new version by reading their entry in present versions column of the version control record. Each component that requires upgrade can perform the upgrade when the cluster coordination component starts the respective component synchronously. In one embodiment, the respective component can initiate an asynchronous upgrade at this time. For example, if persistent data structures change and a large amount of data must undergo data format conversion, the conversion can be time consuming. In this case an asynchronous upgrade is desirable. Once the component completes upgrading, it commits the upgrade by updating the present versions entry in the version control record so that it contains only the new version for the respective component. When all components have completed upgrading, the cluster version is fully upgraded. At this point clients of the clustered application can be stopped one at a time and upgraded to a new client software version compatible with the new capabilities of the upgraded cluster. In addition, any cluster member that was not available to upgrade during the group upgrade either because they were down or had failed during the group upgrade process, will automatically determine the appropriate protocol and data format versions when it reads the version control record prior to rejoining the cluster. For example, the protocol used to re-join the cluster may even have undergone a change. Accordingly, the second part of the cluster upgrade process supports each cluster member remaining operational during the upgrade process.

FIG. 10 is a block diagram (700) of the version control record (705) when the cluster upgrade is in progress and the cluster coordination component has completed its upgrade. As shown, the record indicates each component other than the cluster coordination component is continuing to operate at component version 1. Each component in the current version column (715) is shown as attempting to reach version 2, and each component in the previous version column (720) indicates the prior version at 1. The cluster coordination component (722) in the present versions column (725) indicates the present version of the software is at version 2, and the software versions column (730) indicates that all members of the cluster have been upgraded to running software binary version 2.

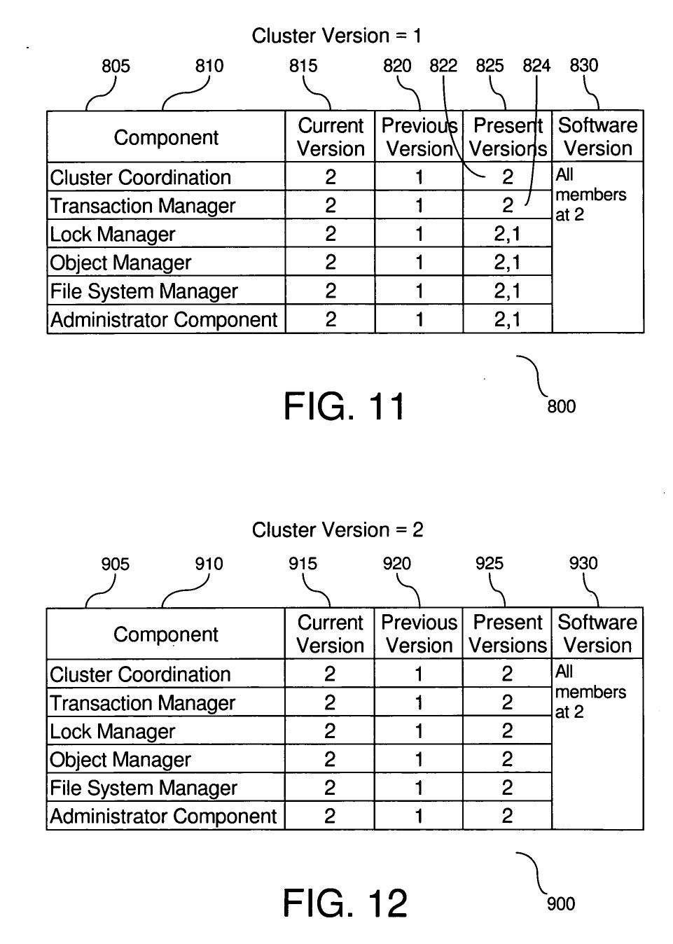

FIG. 11 is a block diagram (800) of the version control record (805) when the cluster upgrade is in progress and the cluster coordination component and transaction manager component have completed their upgrades. As shown, the record indicates that each other component of the cluster is continuing to operate at component version 1. Each component in the current version column (815) is shown as targeting version 2, and each component in the previous version column (820) indicates the prior version at 1. Both the cluster coordination component (822) and the transaction manager component (824) in the present versions column (825) indicate the present version of the software is at version 2, and the software versions column (830) indicates that all members of the cluster have been upgraded to software binary version 2. As reflected in the version control record, the cluster upgrade is still in progress with the cluster coordination and transaction manager components being the only components committed to the new version.

Once the upgrade is complete for each component, the cluster upgrade is complete. FIG. 12 is a block diagram (900) of the version control record (905) when the cluster upgrade is complete. As shown, the record indicates the cluster is operating at version 2. Each component in the current version column (915) is shown at version 2, each component in the previous version column (920) indicates the prior version at 1, each component in the present versions column (925) indicates the single present version of 2, and the software versions column (930) indicates that all members of the cluster have been upgraded to software binary version 2. Accordingly, as reflected in the version control record, the cluster upgrade has been completed from version 1 to version 2, and the cluster is now prepared to proceed with any subsequent upgrades from version 2 to a later version.

The method for upgrading a cluster software version in the two phase process illustrated in detail in FIGS. 7 and 9 above is conducted in a rolling fault tolerant manner that supports inter-node communication throughout the upgrade process. This enables the cluster upgrade to be relatively transparent to clients being serviced by the cluster members. The version control record contains enough information that any node can assume the coordination role after a failure of the cluster leader at any point in the coordinated transition and drive the upgrade to conclusion. Likewise, any non-coordinator node that experiences failure during the transition to new versions will discover and read the state of the version control record at rejoin time and determine the appropriate protocols and data structure formats.

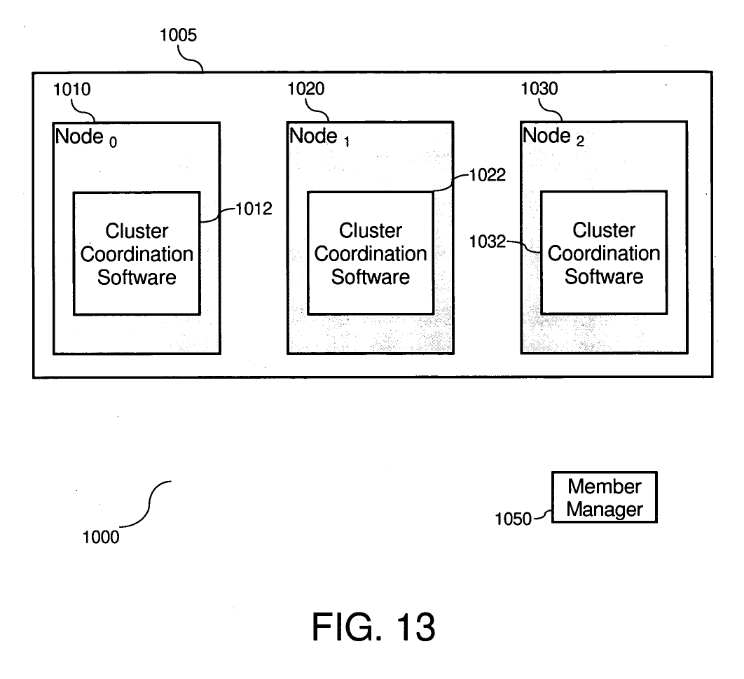

The method for upgrading the cluster software version may be invoked in the form of a tool that includes a member manager and a cluster manager. FIG. 13 is a block diagram (1000) of a cluster (1005) of three nodes (1010), (1020), and (1030). As noted above, a cluster includes a set of one or more nodes which run instances of cluster coordination software to enable applications running on the nodes to behave as a cohesive group. The quantity of nodes in the cluster are merely an illustrative quantity. The system may be enlarged to include additional nodes, and similarly, the system may be reduced to include fewer nodes. As shown, Node₀ (1010) has cluster coordination software (1012), Node₁ (1020) has cluster coordination software (1022), and Node₂ (1030) has cluster coordination software (1032). The cluster coordination softwares collectively designates one of the nodes as a cluster leader which is responsible for coordinating all cluster wide transitions. The cluster leader is also known as the cluster manager. Through the cluster coordination softwares, any cluster member can become a cluster leader in the event of failure of the designated cluster leader. In addition, a member manager (1050) is provided to communicate with the individual cluster members to coordinate a software binary upgrade which is a pre-requisite to the coordinated cluster software upgrade. The member manager may be remote from the cluster, local to the cluster, or a manual process implemented by an administrator. The member manager may be responsible for individually stopping, upgrading software binaries, and restarting each cluster member to reach software parity. The cluster manager drives the cluster upgrade to conclusion following receipt of a communication from the member manager that all of the software binaries for each member have been upgraded in preparation for the cluster upgrade.

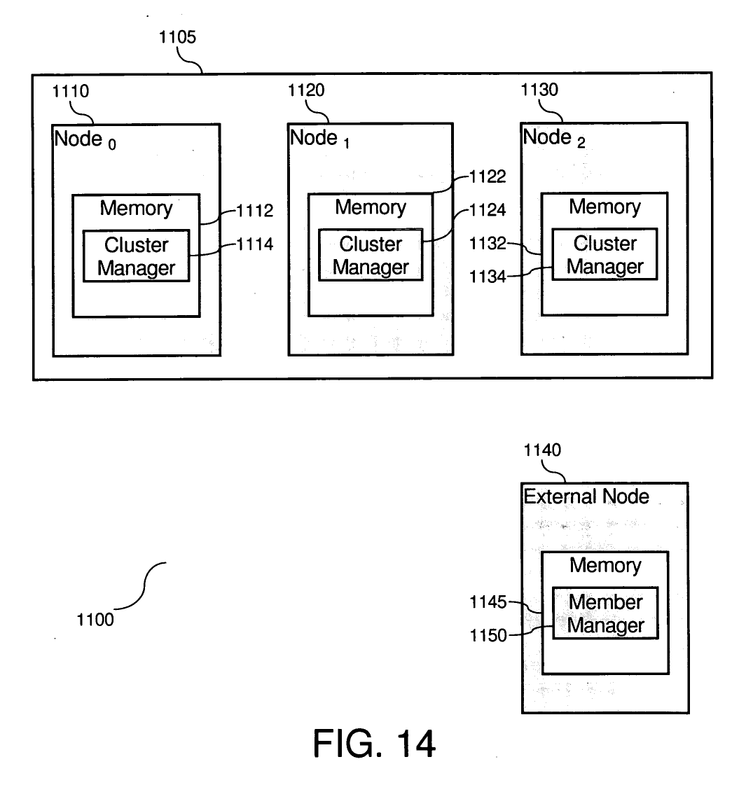

In one embodiment, the invention is implemented in software, which includes but is not limited to firmware, resident software, microcode, etc. The software implementation can take the form of a computer program product accessible from a computer-useable or computer-readable medium providing program code for use by or in connection with a computer or any instruction execution system. FIG. 14 is a block diagram (1100) of a cluster (1105) of three nodes (1110), (1120), and (1130). As noted above, a cluster includes a set of one or more nodes which run instances of cluster coordination software to enable the applications running on the nodes to behave as a cohesive group. The quantity of nodes in the cluster are merely an illustrative quantity. The system may be enlarged to include additional nodes, and similarly, the system may be reduced to include fewer nodes. Each of the nodes in the cluster includes memory (1112), (1122), and (1132), with the cluster manager residing therein. As shown, Node₀ (1110) has cluster manager (1114), Node₁ (1120) has cluster manager (1124), and Node₂ (1130) has cluster manager (1134). In addition, as noted above a member manager (1150) is provided to communicate with the individual cluster members to coordinate a software binary upgrade which is a pre-requisite to the coordinated cluster software upgrade. As shown herein, the member manager (1150) resides in memory (1145) on an external node (1140), although it could reside on memory local to the cluster. For the purposes of this description, a computer-useable or computer-readable medium can be any apparatus that can contain, store, communicate, propagate, or transport the program for use by or in connection with the instruction execution system, apparatus, or device.

### Advantages Over the Prior Art

A fault tolerant upgrade of cluster software is conducted in two phases. The first phase is an upgrade of the software binaries of the individual cluster members, and the second phase is an coordinated upgrade of the cluster to use the new software. During both the first and second phases of the upgrade, the cluster remains at least partially online and available to service client requests. If during the cluster upgrade any one of the cluster members experiences a failure and leaves the cluster, including the cluster leader, the upgrade continues and may be driven to conclusion by any cluster member with access to the shared storage system. Once the cluster upgrade is in progress in the second phase, there is no requirement to re-start the upgrade in the event of failure of any of the nodes. Accordingly, the cluster software upgrade functions in a fault tolerant manner by enabling the cluster to upgrade software and transition to using new functionality, on disk structures, and messaging protocols in a coordinated manner without any downtime.

### Alternative Embodiments

It will be appreciated that, although specific embodiments of the invention have been described herein for purposes of illustration, various modifications may be made without departing from the spirit and scope of the invention. In particular, although the description relates to a storage area network filesystem, it may be applied to any clustered application service with access by all members to shared storage. Accordingly, the scope of protection of this invention is limited only by the following claims and their equivalents.

We claim:

1. A method of upgrading software in a cluster, comprising:
reaching software parity for said cluster by individually upgrading software binaries for each member of said cluster to a new software version from a prior version while each cluster member continues to operate at a prior software version; and
coordinating a fault tolerant transition of said cluster to said new software version responsive to reaching software parity while supporting continued access to a clustered application service by application clients during said transition of said cluster to said new software version.

2. The method of claim 1, wherein the step of reaching software parity for said cluster includes each member with said new software version continuing to participate in the cluster under a prior software version until completion of said coordinated transition of all cluster members.

3. The method of claim 1, wherein components of said new software version and said prior software version differ in format.

4. The method of claim 1, wherein the step of coordinating a fault tolerant upgrade of said cluster includes utilizing a cluster leader to drive said upgrade to conclusion, wherein said cluster leader is selected from a group consisting of: an original cluster leader, and another member of the cluster that has assumed a cluster leader role in event of fault of said original cluster leader.

5. The method of claim 1, wherein the step of coordinating a fault tolerant upgrade of said cluster includes updating a version control record in shared persistent storage.

6. The method of claim 5, further comprising transitioning any node joining said cluster subsequent to a cluster version upgrade through said joining node reading said version control record.

7. A computer system comprising:
a member manager adapted to reach software parity for a cluster through an upgrade of software binaries for each individual member of said cluster to a new software version from a prior version while each cluster member continues to operate at a prior software version; and
a cluster manager adapted to coordinate a fault tolerant transition of said cluster to said new software version, responsive to attainment of software parity by said member manager, and to support continued application service to application clients during said coordinated transition.

8. The system of claim 7, wherein said cluster manager supports continued participation of each cluster member with a new software version in said cluster under a prior software version until completion of execution of said coordinated transition of all cluster members.

9. The system of claim 7, wherein components of said new software version and said prior software version differ in a format.

10. The system of claim 7, wherein a cluster leader drives said upgrade to conclusion and said cluster leader is selected from a group consisting of: an original cluster leader, and another member of the cluster that has assumed a cluster leader role in event of fault of said original cluster leader.

11. The system of claim 7, wherein said cluster manager updates a version control record in shared persistent storage.

12. The system of claim 11, wherein said cluster manager coordinates transition of any node joining said cluster subsequent to a cluster version upgrade through a read of said version control record by said joining node.

13. An article comprising:
a computer useable medium embodying computer usable program code for upgrading a cluster, said computer program code including:
computer useable program code for reaching software parity for said cluster by individually upgrading software binaries to a new software version from a prior version while each cluster member continues to operate at a prior software version; and
computer useable program code for coordinating a fault tolerant transition of said cluster to said new software version in response to reaching software parity while supporting continued access to a clustered application service by application clients during said transition of said cluster to said new software version.

14. The article of claim 13, wherein said computer useable program code for reaching software parity for said cluster supports continued participation in said cluster of each member with a new software version under said prior software version until completion of said coordinated transition of all cluster members.

15. The article of claim 13, wherein components of said new software version and said prior software version differ in format.

16. The article of claim 13, wherein said computer useable program code for coordinating a fault tolerant transition of said cluster includes utilizing a cluster leader to drive said upgrade to conclusion, wherein said cluster leader is selected from a group consisting of: an original cluster leader, and another member of the cluster that has assumed a cluster leader role in event of fault of said original cluster leader.

17. The article of claim 13, wherein said computer useable program code for coordinating a fault tolerant transition of said cluster to said new software version includes updating a version control record in shared persistent storage.

18. The article of claim 17, further comprising computer useable program code for transitioning any node joining said cluster subsequent to a cluster version upgrade through said joining node reading said version control record.
